(19) United States
(12) Patent Application Publication
(10) Pub. No.: US 2026/0353195 A1
(43) Pub. Date: Nov. 5, 2026

(54) Network Node, User Equipment, Radio Network Nodes, and Methods Performed Therein

(71) Applicant: Telefonaktiebolaget LM Ericsson (publ), Stockholm (SE)

(72) Inventors: Nianshan Shi, Järfälla (SE); Yazid Lyazidi, London (GB)

(21) Appl. No.: 19/487,721

(22) PCT Filed: May 28, 2024
(86) PCT No.: PCT/SE2024/050522

§ 371 Date: Nov. 25, 2025

Related U.S. Application Data
(60) Provisional application No. 63/505,072, filed on May 31, 2023.

(51) Int. Cl. H04W 28/24; H04L 67/131

(52) U.S. Cl. CPC H04W 28/24; H04L 67/131

(57) ABSTRACT

Embodiments herein relate to, for example, a method performed by a UE (10) for handling communication of UEs in a communication network. The UE (10) transmit an indication of group information to a first radio network node (12), wherein the indication indicates grouping of UEs participating in an XR session or application and/or information relating to the XR session or application.

### TECHNICAL FIELD

Embodiments herein relate to a network node, a user equipment (UE), a first radio network node, a second radio network node, and methods performed therein regarding wireless communication. Furthermore, a computer program product and a computer readable storage medium are also provided herein. In particular, embodiments herein relate to handling communication of UEs in a communication network.

### BACKGROUND

In a typical communication network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate e.g. enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions. NR is connected to the 5G Core Network (5GC) which comprises a number of Network Functions (NF) such as Session Management Function (SMF), Access Management Function (AMF), Authentication Service Function (AUSF), Policy Control Function (PCF), Unified Data Manager (UDM), Network Repository Function (NRF), Network Exposure Function (NEF), just to mention some. In the 5GC, NFs can discover other NFs by using a discovery service provided by the Network Repository Function (NRF).

Augmented reality (AR) may be defined as an interactive experience that combines the real world and computer-generated content. The content can span multiple sensory modalities, including visual, auditory, haptic, somatosensory, and olfactory. AR can be defined as a system that incorporates three basic features: a combination of real and virtual worlds, real-time interaction, and accurate three-dimensional (3D) registration of virtual and real objects.

In addition to the “AR” term the industry uses two other related terms. A mixed reality (MR) is an advanced form of AR where some virtual elements are inserted into the physical scene with the intent to provide the illusion that these elements are part of the real scene. An extended reality (XR) refers to all real-and-virtual combined environments and human-machine interactions generated by computer technology and wearables. It includes representative forms such as AR, MR and virtual reality (VR) and the areas interpolated among them. The levels of virtuality range from partially sensory inputs to fully immersive VR. A key aspect of XR is the extension of human experiences especially relating to the senses of existence, represented by VR, and the acquisition of cognition, represented by AR.

While it is herein mostly used the “XR” term in the description the “MR” and “AR” may equally be applied to embodiments herein.

XR traffic characteristics.

XR applications typically generate traffic flows which are in principle periodic, e.g., video traffic with 30, 60, 90, or 120 frame per second (fps). However, the traffic arrival moment at the RAN is affected by jitter around the periodicity value, due to processing of the frames at the application, e.g., for compression, and the capabilities of the platform used by the application, as well as transmission through the Core Network. This is modelled in 3GPP TR 38.838 v.16.0.0, by assuming that each data frame arriving at the RAN has a random jitter of [−4; +4] ms, optionally [−5; +5] ms, around the main periodicity. The probability of the jitter value within this interval is given by a truncated Gaussian distribution with mean 0 ms and standard deviation 2 ms.

However, it is expected that XR traffic will be more dynamic. In response to events, e.g., network events, such as congestion indications, or application/user triggered events, XR traffic is likely to adapt/change its traffic pattern. For example, an application may react to congestion notification and may react by lowering the transferred video quality, lowering the bitrate. In another example the application may react by lowering the frame rate, for example from 90 fps to 30 fps, such adaptation is likely to impact the characteristics of the traffic pattern, e.g., periodicity.

XR traffic has strict delay requirements, for example, in terms of packet delay budget (PDB). This is the maximum tolerable delay for a packet to be transmitted from a gNB to a UE. The PDB value depends on the XR traffic type and is overall between 5 ms and 30 ms.

3GPP has approved the release (Rel)-18 SA and RAN Work Item on XR.

Further enhancements on XR user cases, e.g., gaming are to be investigated in the later release, such as Release-19.

The overall 5G RAN (NG-RAN) architecture is depicted in FIG. 1.

The gNB with a split architecture is depicted in FIG. 2.

A gNB-central unit (CU) hosts the radio resource control (RRC) and the control plane part of the packet data convergence protocol (PDCP); and a gNB-distributed unit (DU) hosts radio link control (RLC), medium access control (MAC) and the physical layer (PHY).

In Dual Connectivity, a master node (MN) and a secondary node (SN) host separate RRC in Control plane and MAC layer in User plane, see FIG. 3

### SUMMARY

As part of developing embodiments herein one or more problems have been identified.

In XR gaming, multi-player is an acknowledged user case. Furthermore, very often multiple UEs are involved in an XR experience, such as VR or AR.

An object of embodiments herein is to handle communication of UEs in a communication network to improve performance when handling an XR service or application.

According to an aspect the object is achieved, according to some embodiments herein, by providing a method performed by a first radio network node, such as an gNB, for handling communication of UEs in a communication network. The first radio network node obtains an indication of group information from a UE or a network node, for example, a group associated with an XR service or application in the communication network. The indication indicates grouping of UEs participating in an XR session or application and/or information relating to the XR session or application; The first radio network node then performs a performance action relating to performance of the XR session or application based on the obtained indication.

According to another aspect the object is achieved, according to some embodiments herein, by providing a method performed by a user equipment for handling communication of UEs in a communication network. The UE transmits an indication of group information to a first radio network node, wherein the indication indicates grouping of UEs participating in an XR session or application and/or information relating to the XR session or application.

According to another aspect the object is achieved, according to some embodiments herein, by providing a method performed by a network node for handling communication of UEs in a communication network. The network node transmits to a first radio network node, an indication of group information, for example, a group associated with an XR service or application in the communication network. The indication indicates grouping of UEs participating in an XR session or application and/or information relating to the XR session or application, such as time sensitive communication assistance information (TSCAI), quality of service (QoS), requirements or similar.

According to another aspect the object is achieved, according to some embodiments herein, by providing a method performed by a second radio network node for handling communication of UEs in a communication network. The second radio network node receives from a first radio network node a message relating to one or more UEs associated with a group of UEs handling or participating in an XR session or application. The second radio network node performs a performance action relating to performance of the XR session or application, based on the message.

It is furthermore provided herein a computer program product comprising instructions, which, when executed on at least one processor, cause the at least one processor to carry out the methods herein, as performed by the radio network nodes, the UE, or the network node, respectively. It is additionally provided herein a computer-readable storage medium, having stored thereon a computer program product comprising instructions which, when executed on at least one processor, cause the at least one processor to carry out the method according to the methods herein, as performed by the radio network nodes, the UE or the network node, respectively.

Furthermore, according to another aspect the object is achieved, according to some embodiments herein, by providing a first radio network node, a second radio network node, a network node and a user equipment configured to perform the methods herein, respectively.

Thus, according to an aspect the object is achieved, according to some embodiments herein, by providing a first radio network node, such as an gNB, for handling communication of UEs in a communication network. The first radio network node is configured to obtain an indication of group information from a UE or a network node. The indication indicates grouping of UEs participating in an XR session or application and/or information relating to the XR session or application; The first radio network node is further configured to perform a performance action relating to performance of the XR session or application based on the obtained indication.

According to yet another aspect the object is achieved, according to some embodiments herein, by providing a user equipment for handling communication of UEs in a communication network. The UE is configured to transmit an indication of group information to a first radio network node, wherein the indication indicates grouping of UEs participating in an XR session or application and/or information relating to the XR session or application.

According to still another aspect the object is achieved, according to some embodiments herein, by providing a network node for handling communication of UEs in a communication network. The network node is configured to transmit to a first radio network node, an indication of group information. The indication indicates grouping of UEs participating in an XR session or application and/or information relating to the XR session or application, such as TSCAI, QoS, requirements or similar.

According to another aspect the object is achieved, according to some embodiments herein, by providing a second radio network node for handling communication of UEs in a communication network. The second radio network node is configured to receive from a first radio network node, a message relating to one or more UEs associated with a group of UEs handling or participating in an XR session or application. The second radio network node is further configured to perform a performance action relating to performance of the XR session or application, based on the message.

According to embodiments herein, a first RAN, i.e., the first radio network node, is made aware of the XR UE groups or device groups participating in an XR session. Also herein referred to as XR UE group awareness.

With this indication, embodiments in the RAN may be introduced to perform performance actions to optimize on, for example, the resource allocation, scheduling design, Dual connectivity setup, and/or handover preparation for the given XR UE groups.

For multiple players such as UEs, the UEs may use the same gNB, or different gNBs at different geographic areas. Coordination's among the involved radio network nodes may thus be needed, either directly via Xn interface, or via Core Network (NG interface). For XR UE group awareness, the UEs involved may be residing at the same location.

According to embodiments here, it is herein provided an efficient handling of communication of UEs in the communication network improving the user experience when handling XR service or application.

### BRIEF DESCRIPTION OF THE DRAWINGS

Embodiments will now be described in more detail in relation to the enclosed drawings, in which:

FIG. 1 is a schematic overview depicting architecture according to prior art;

FIG. 2 is a schematic overview depicting architecture according to prior art;

FIG. 3 is a schematic overview depicting architecture according to prior art;

FIG. 4 shows an overview depicting a communication network according to embodiments herein;

FIG. 5a is a combined flowchart and signaling scheme according to embodiments herein;

FIG. 5b is a combined flowchart and signaling scheme according to embodiments herein;

FIG. 5c is a combined flowchart and signaling scheme according to embodiments herein;

FIG. 6a shows a flowchart illustrating a method performed by a UE according to embodiments herein;

FIG. 6b shows a flowchart illustrating a method performed by a first radio network node according to embodiments herein;

FIG. 6c shows a flowchart illustrating a method performed by a second radio network node according to embodiments herein;

FIG. 6d shows a flowchart illustrating a method performed by a network node according to embodiments herein;

FIG. 7a is a combined flowchart and signaling scheme according to embodiments herein;

FIG. 7b is a combined flowchart and signaling scheme according to embodiments herein;

FIG. 7c is a combined flowchart and signaling scheme according to embodiments herein;

FIG. 8a shows a block diagram depicting embodiments of a UE according to embodiments herein;

FIG. 8b shows a block diagram depicting embodiments of a network node according to embodiments herein;

FIG. 9 shows a block diagram depicting embodiments of a first radio network node according to embodiments herein;

FIG. 10 shows a block diagram depicting embodiments of a second radio network node according to embodiments herein;

FIG. 11 shows an example of a communication system QQ100 in accordance with some embodiments;

FIG. 12 shows a UE QQ200 in accordance with some embodiments;

FIG. 13 shows a network node QQ300 in accordance with some embodiments;

FIG. 14 is a block diagram of a host QQ400, which may be an embodiment of the host QQ116 of FIG. 11, in accordance with various aspects described herein;

FIG. 15 is a block diagram illustrating a virtualization environment QQ500 in which functions implemented by some embodiments may be virtualized; and

FIG. 16 shows a communication diagram of a host QQ602 communicating via a network node QQ604 with a UE QQ606 over a partially wireless connection in accordance with some embodiments.

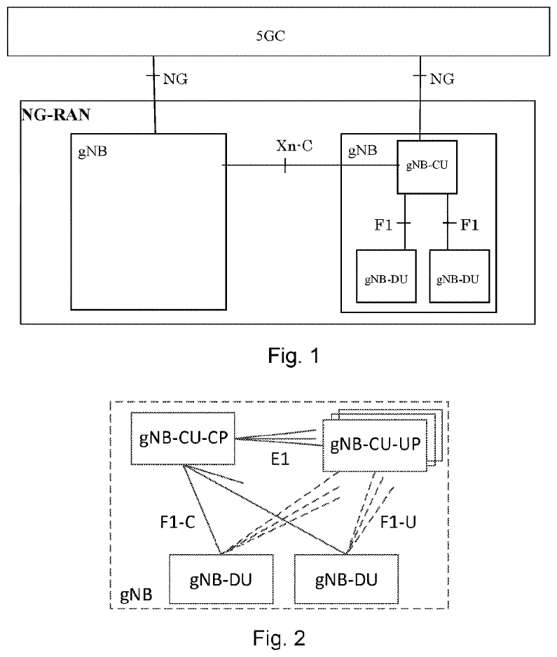

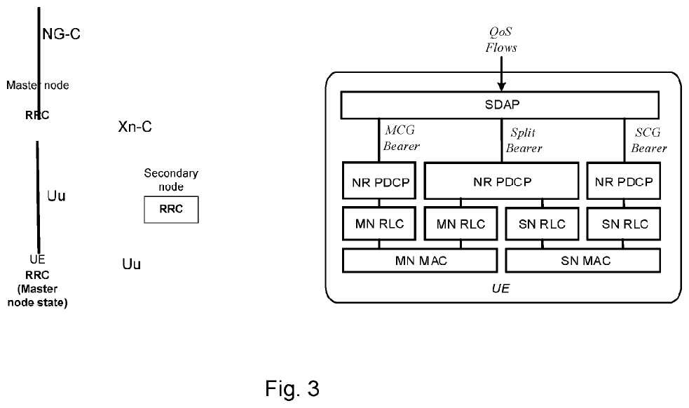

### DETAILED DESCRIPTION

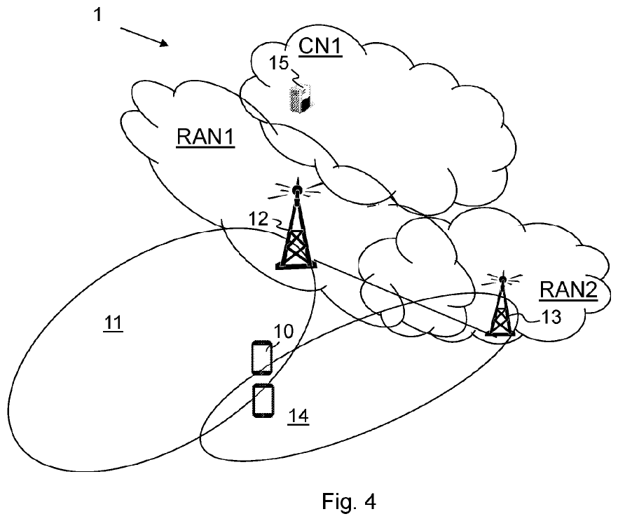

Embodiments herein relate to communication networks in general. FIG. 4 is a schematic overview depicting a communication network 1. The communication network 1 comprises one or more RANs and one or more CNs. The communication network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the communication network 1, one or more UEs such as a user equipment (UE) 10 exemplified herein as a wireless device such as a mobile station, a non-access point (non-AP) station (STA), a STA and/or a wireless terminal, are comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The communication network 1 comprises a first radio network node 12 or just radio network node, providing radio coverage over a geographical area, a first service area 11 or first cell, of a first radio access technology (RAT), such as NR, LTE, or similar. The radio network node 12 may be a transmission and reception point such as an access node, an access controller, a base station, e.g. a radio base station such as an NG-RAN node, a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within the area served by the first radio network node depending e.g. on the first radio access technology and terminology used. The first radio network node may be referred to as a serving radio network node wherein the service area may be referred to as a serving cell, and the serving network node communicates with the wireless device in form of DL transmissions to the wireless device and UL transmissions from the wireless device. It should be noted that a service area may be denoted as cell, beam, beam group or similar to define an area of radio coverage.

The communication network 1 comprises a second radio network node 13 or just radio network node, providing radio coverage over a geographical area, a second service area 14 or second cell, of a second radio access technology (RAT), such as NR, LTE, or similar. The second radio network node 13 may be a transmission and reception point such as an access node, an access controller, a base station, e.g. a radio base station such as an NG-RAN node, a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the second radio network node depending e.g. on the first radio access technology and terminology used. The second radio network node may be referred to as a visiting radio network node or target radio network node, wherein the service area may be referred to as a visiting cell or target cell, and the second radio network node communicates with the UE in form of DL transmissions to the UE and UL transmissions from the UE. It should be noted that a service area may be denoted as cell, beam, beam group or similar to define an area of radio coverage.

The first RAT may be the same RAT as the second RAT or the first RAT may be a different RAT than the second RAT.

The communication network 1 may further comprise a number of network nodes providing, e.g. in NR, applications, such as an application server (AS), or network functions (NF) or actually instantiations of NFs also referred to as NF instances, such as a first network node 15, also referred to as network node 15, providing, for example, an XR application, an instantiation of an AMF, or any other NF instances in the communication network 1. The different NF instances may have different tasks. Other functions may be for LTE such as mobility management entity (MME) or similar.

The respective node may be a standalone server, a cloud-implemented server, a distributed server or processing resources in a server farm or same node. Embodiments herein may be implemented as physical bare metal, virtual or cloud native such as Kubernetes environment in e.g. hyper-cloud networks.

According to embodiments herein, the UE 10 or the network node 15 may transmit an indication of group information to the first radio network node 12. The indication indicates grouping of UEs participating in an XR session or application and/or information relating to the XR session or application, such as TSCAI, QoS, requirements or similar. Thus, one or more radio network nodes may be made aware of the group information related to the XR session or application. The first radio network node 12 and/or the second radio network node 13 may then perform a performance action relating to performance of the XR session or application taking the indication into account.

In embodiments herein, UEs, such as multiplayers, multiple XR devices, or multi devices, may be grouped either via application, subscription or other means. The grouping may be performed at the UE level or via an application server or a network node. The grouping may be based on the XR service and/or the XR application or session. One or more radio network nodes, such as NG-RAN nodes, are made aware of the UEs belonging to the same group of the application or service, and may need coordination, e.g., to move into the game level together, or to wave two hands, act and see at the same time.

The indication, also referred to as “grouping information”, may be achieved or obtained either by associating the UE identities, or by allocating a unique group ID, e.g. unique within public land mobile network (PLMN), or the tracking area, etc.

The radio network nodes may be made aware of the indication from the UE 10, e.g., from radio resource control (RRC) signaling, or from an application, i.e., the network node 15, via the CN interface to the radio network nodes.

When the UEs are served by the radio network nodes, the radio network nodes are made aware of each other via CN, or via Xn interface. Radio resource management (RRM) information may be exchanged, for example, in a message to each radio network node. The serving cell/node may use the RRM information from the other radio network node and adjust the processing, to ensure that the UEs are synchronized and can have access to the same or similar amount of resources required by an XR Multiplayer service.

When the UEs are served by the same radio network node such as the first radio network node 12, the radio network node may perform the performance action such as:
make enhancements on scheduling, e.g. base station resources are synchronized taking the group information into account;
during Handover, make sure the UEs are handed over to a same radio network node;
when setting up the Dual Connectivity, make sure same MN and SN nodes are used;
If same gNB-DU, share the same logical channel (LCH) resources; and/or
If different gNB-DUs are used, the assistance data are sent from a gNB-DU to a gNBCU to align, e.g., UE discontinuous reception (DRX)/Cell DRX, measurement Gap configurations, periodicity, or similar.

For a handover procedure: the UEs that belong to the same group are using the same serving radio network node, one or more of the following may be performed as performance actions:
When a first UE, UE A, needs to perform handover, the network may handover a second UE, UE B, e.g., a list of UEs in the same group, to a same target radio network node such as the second radio network node 13;
A first radio network node 12 may remember where the UE A has been handed over, and when the UE B requires handover, the first radio network node 12 may hand over to the same target radio network node;
The serving first radio network node 12 may maintain the UE context of the UE A, even if the UE A has moved to another target radio network node, when UEs belonging to the same group are still served by the first radio network node 12. The new serving RAN node for the UE A, such as the second radio network node 13, may keep the old serving node or nodes updated about changes in UE A context. This ensures that during mobility, the network serving the UEs always know where the members are served in the network and coordination is possible;
When the UE A needs to be handed over, then first radio network node 12 may indicate to the group, such as a list of UEs, that a handover should be performed by the group. The first radio network node 12 may send the list of the UE to be handed over to the target radio network node, e.g., during a group handover. The second radio network node 13 may send the feedback indicating failure and success of the handover of group of UEs, and/or which UEs succeeded and for which UEs group handover has failed.

It should be noted that the second radio network node 13 may receive a handover indication that the group of UEs are handed over for an XR session or application, so that the second radio network node 13 may prioritize the handover.

If UEs, e.g., a UE A and a UE B, in the group are not served by the same radio network node, maybe not even in the same region:
The first radio network node 12 serving the UE A may be made aware of the serving second radio network node 13 of the UE B, and vice versa, in the same group, so that radio network nodes can exchange certain RRM information, passed as transparent container via CN or X2, e.g. DRX, measurement Gap configuration, burst arrive time and/or offset adjustment. When these UEs are performing handover to one or more target radio network nodes, the indication may be passed to the target radio network node, such as the second radio network node 13, and the target radio network node may keep maintaining the awareness of the other UEs in the group.

The topology of UE groups, e.g., which radio network nodes serve which UEs, may be maintained, e.g. by application, or some central network nodes. When coordination is required, the topology may be distributed to the radio network nodes serving the UE groups. This may be a service provided or a subscription add-on. The radio network nodes and/or network nodes interested in the information may request to receive such topology information. The radio network nodes collecting the information may request the radio network nodes serving the UE to report and update such topology information.

Embodiments herein enable a coordination among radio network nodes to support grouping UEs for a XR multiplayer service or application, such as supporting handover of one or more UEs.

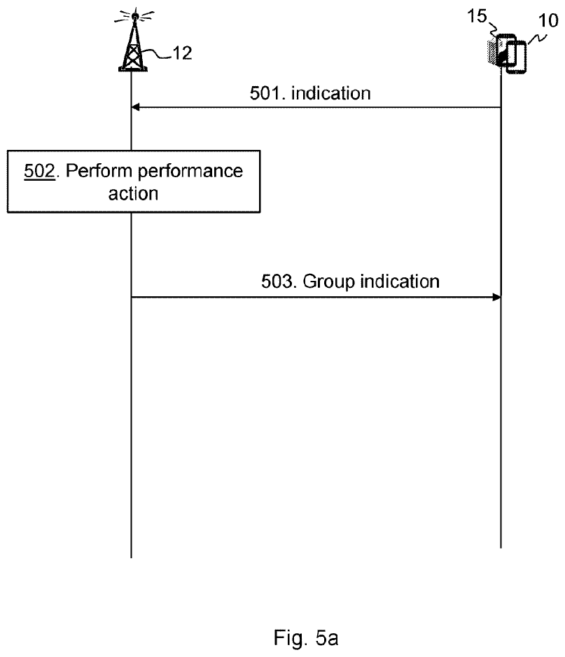

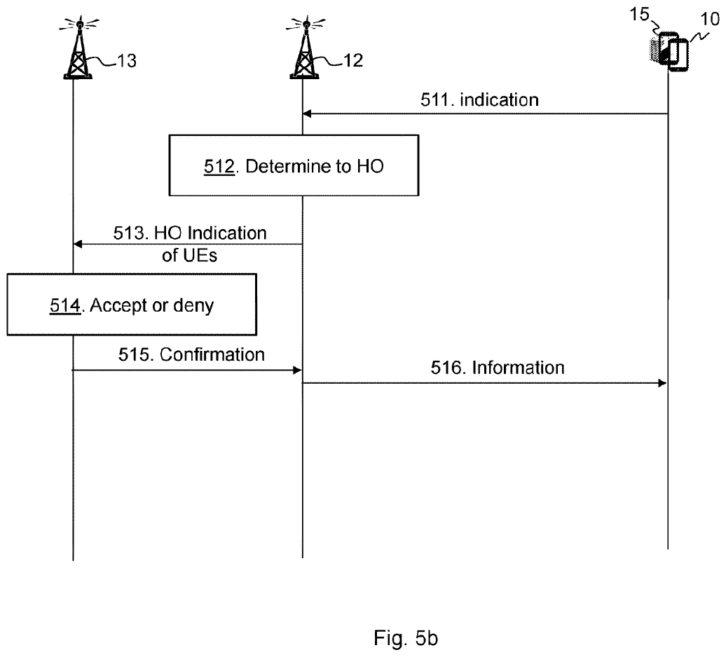

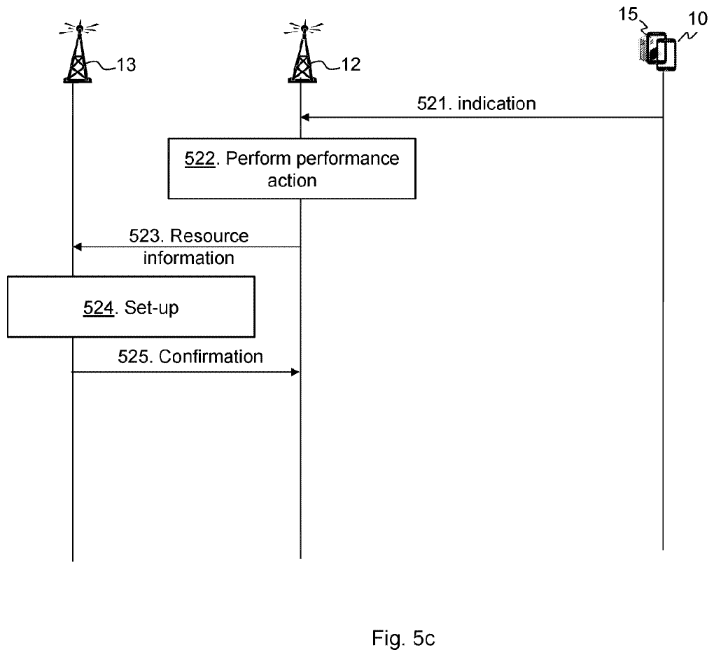

FIG. 5a is a combined flow chart and signaling scheme according to some embodiments herein when UEs are served by the first radio network node 12.

Action 501. The UE 10 or the network node 15 may provide the indication of group information to the first radio network node 12. For example, the network node 15 may transmit a list of UEs or an identity indicating a group ID of an application such as an XR application.

Action 502. The first radio network node 12 then performs a performance action relating to the performance of the XR session or application, such as handling: resource allocation, scheduling design, Dual connectivity setup and/or handover preparation for the given group of UEs taking the indication into account, i.e., based on whether the XR session or application is for a group of UEs.

Action 503. The first radio network node 12 may then indicate, with a group indication, data or information related to the performance action and/or the indication. This may be provided, or transmitted, to the network node 15, the UE 10 and/or the second radio network node 13.

FIG. 5b is a combined flow chart and signaling scheme according to some embodiments herein when the UE 10 is handed over from the first radio network node 12 to the second radio network node 13.

Action 511. The UE 10 or the network node 15 may provide the indication such as group information to the first radio network node 12. As an example, the network node 15 may transmit a list of UEs or an identity indicating a group ID of an application such as an XR application.

Action 512. The first radio network node 12 may determine based on reports or similar that the UE 10 should perform a handover to the second radio network node 13.

Action 513. Since the UE 10 is indicated as being a group UE of an XR application or similar, the first radio network node 12 may transmit a list of UEs of the group for the second radio network node 13 for the second radio network node 13 to be informed of the group or to request HO of the group.

Action 514. The second radio network node 13 may accept or deny the request.

Action 515. The second radio network node 13 may further transmit a response back to the first radio network node 12 such as a confirmation.

Action 516. The first radio network node 12 may then indicate data or information related to the HO and/or the group information. This may be provided or transmitted to the network node 15, and/or the UE 10.

FIG. 5c is a combined flow chart and signaling scheme according to some embodiments herein when UEs are served by the first radio network node 12 and the second radio network node 13.

Action 521. The UE 10 or the network node 15 may provide indication of group information to the first radio network node 12. The network node 15 may transmit a list of UEs or an identity indicating a group ID of an application such as an XR application.

Action 522. The first radio network node 12 then performs a performance action such as handling: resource allocation, scheduling design, Dual connectivity setup and/or handover preparation for the given group of UEs.

Action 523. The first radio network node 12 may then transmit or provide a message or information such as resource information to the second radio network node 13 handling one or more other UEs in the group.

Action 524. The second radio network node 13 may then, based on the message, set up resources for handling the XR application or session for a UE (in the group) at the second radio network node 13.

Action 525. The second radio network node 13 may then confirm the set-up resources back to the first radio network node 12.

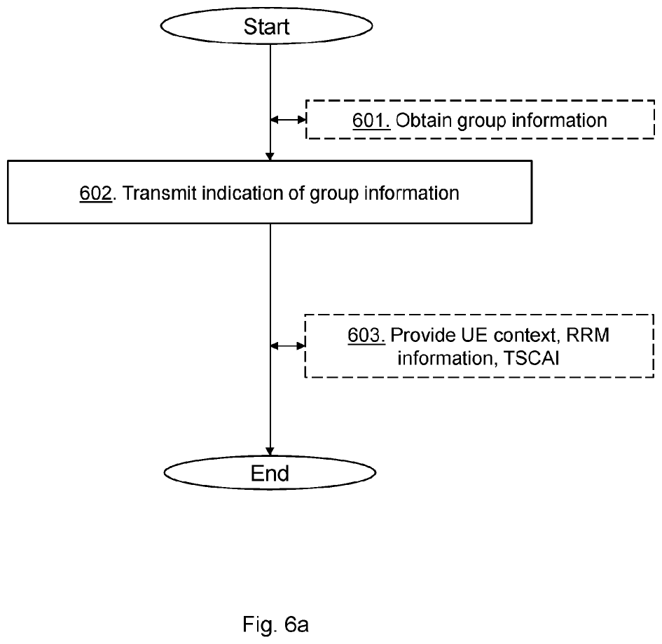

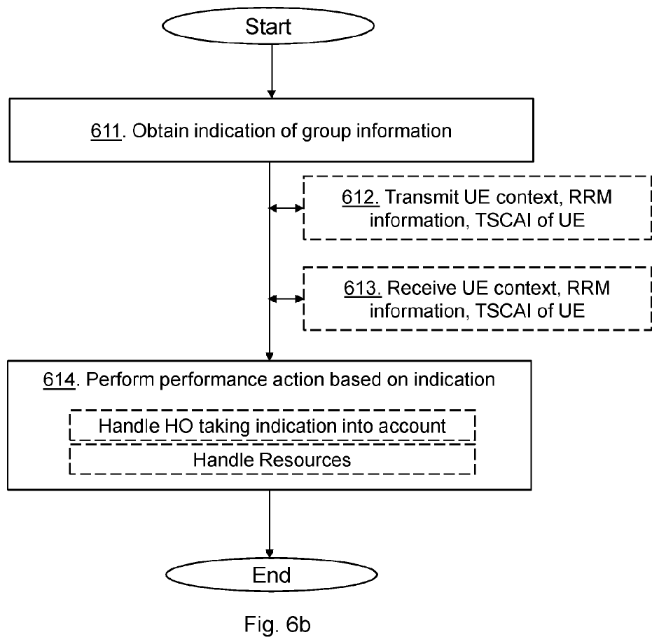

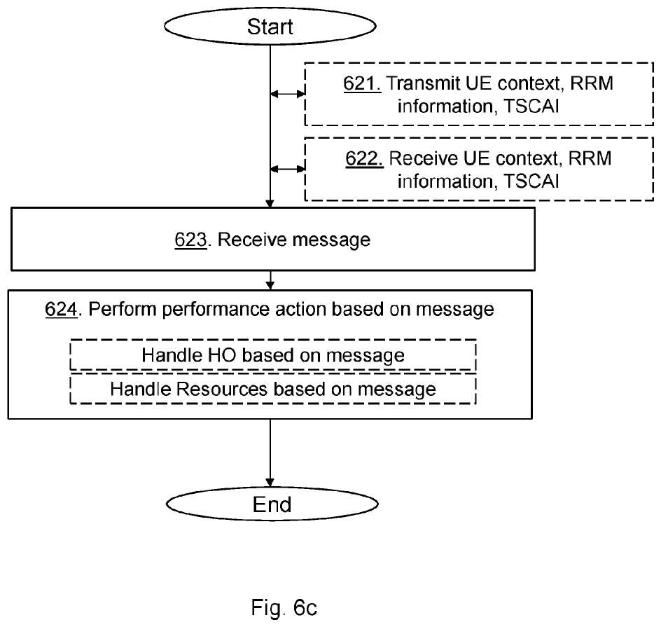

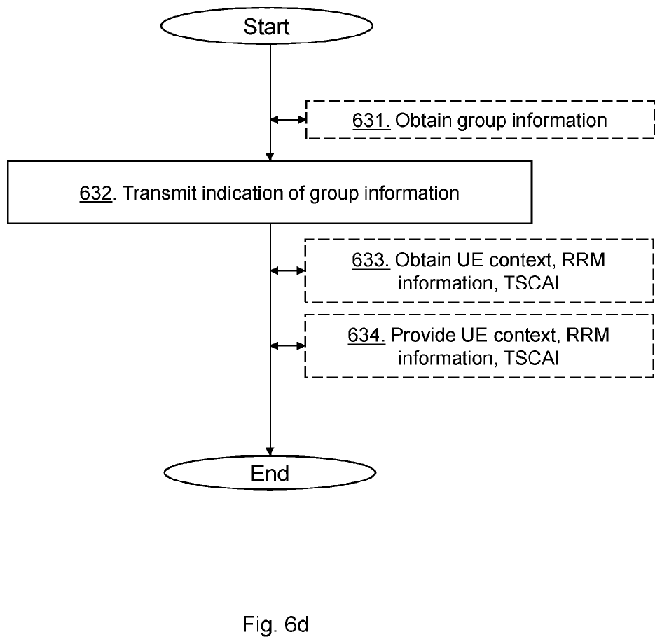

The method actions performed by the UE 10 for handling communication of the UEs in the communication network 1, for example, handling an XR session, according to embodiments herein will now be described with reference to a flowchart depicted in FIG. 6a. The actions do not have to be taken in the order stated below, but may be taken in any suitable order. Actions performed in some embodiments are marked with dashed boxes.

Action 601. The UE 10 may obtain group information. The UE 10 may set, receive or retrieve the group information, for example, from a service or application such as an XR application or service.

Action 602. The UE 10 transmits to the first radio network node 12, the indication of group information. The indication may indicate grouping of UEs participating in an XR session or application and/or information relating to the XR session or application, such as TSCAI, QoS, requirements or similar. The indication may indicate a UE group, for example, a group associated with an XR service or application, in the communication network. Thus, the UE 10 makes the first radio network node 12 aware of an XR UE group.

Action 603. The UE 10 may provide, e.g., transmit to the first or the second radio network node, UE context of one or more UEs, RRM information and/or TSCAI.

Thus:
A UE may send message to network, such as RRC or non access stratum (NAS) signaling, notifying of grouping information,
UEs may be grouped via e.g. a group ID,
and/or
the UE 10 belonging to a group may transmit, to the network node 15, information on the UE group it belongs to, e.g., ID, and its serving NG-RAN's RRM information as well as the traffic characteristic information, such as TSCAI, for the intended XR service.

The method actions performed by the first radio network node 12 for handling communication of UEs in the communication network 1, for example, handling an XR session, according to embodiments herein will now be described with reference to a flowchart depicted in FIG. 6b. The actions do not have to be taken in the order stated below, but may be taken in any suitable order. Actions performed in some embodiments are marked with dashed boxes.

Action 611. The first radio network node 12 obtains the indication of group information, e.g., receive the indication from the UE 10 or the network node 15. The indication indicates grouping of UEs participating in the XR session or application, and/or information relating to the XR session or application, such as TSCAI, QoS, requirements or similar.

Action 612. The first radio network node 12 may transmit to the network node 15 or the second radio network node 13, UE context of one or more UEs, RRM information and/or TSCAI describing time sensitive communication (TSC) flow traffic characteristics of the XR application. The traffic characteristics may include a periodicity and/or a jitter information that should be used by the second radio network node 13 for the purpose of scheduling.

Action 613. The first radio network node 12 may receive from the network node 15 or the second radio network node 13, UE context of one or more UEs, RRM information and/or TSCAI describing TSC flow traffic characteristics of the XR application.

Action 614. The first radio network node 12 performs the performance action relating to performance of the XR session or application, such as resource allocation, scheduling design, Dual connectivity setup and/or handover preparation for the given group of UEs, based on the indication. The performance action may comprise a resource allocation, a scheduling design, a dual connectivity setup and/or a handover preparation for a given group of UEs based on the indication. The first radio network node 12 may handle HO of the UE taking the indication into account, and/or handle resources taking the indication into account. The first radio network node 12 may transmit to the second radio network node 13 a message relating to one or more UEs associated with a group of UEs handling or participating in an XR service, session or application. The message may indicate list of UEs of the group, resource allocation, scheduling design, Dual connectivity setup and/or handover preparation for the given group of UEs. The traffic characteristics may include a periodicity and/or a jitter information that should be used by the second radio network node 13 for the purpose of scheduling.

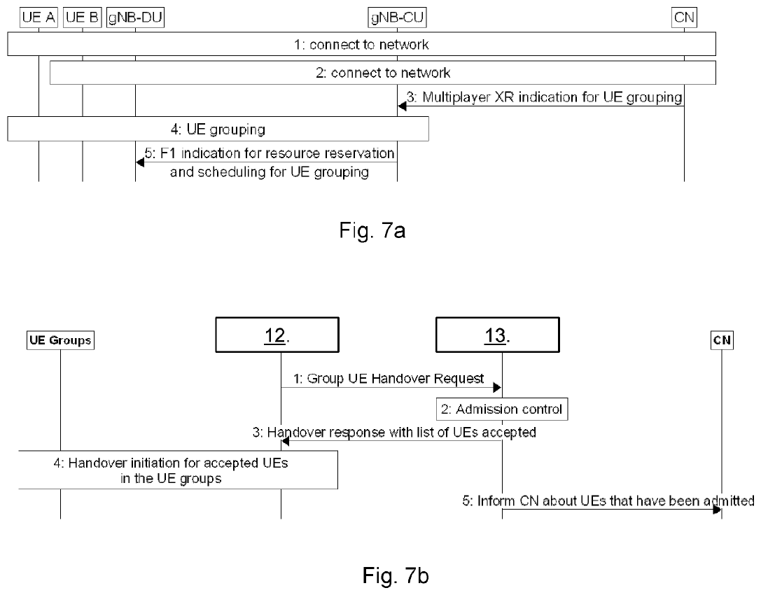

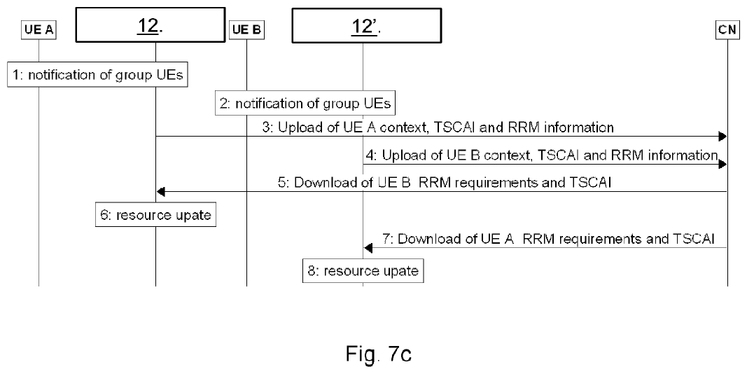

Thus;
the first radio network node 12, or RAN node, may perform a new function for Group UE handover and group UE admission control over Xn with a Group UE Handover response message including the UEs from the group that were successfully accepted for a group handover by the target gNB such as the second radio network node 13.
the first radio network node 12 may update the CN of the UE group after each handover for XR UE group awareness. If UEs from the same group end up in different radio network nodes, the signaling in FIG. 7c may take place. Otherwise, the group may be updated and some UEs may be dropped from the group.
new signaling over Xn, and/or F1 may be introduced about group UE information, including ID, related RRM information and XR traffic information supported by RAN.

The method actions performed by the second radio network node 13 for handling communication of UEs in the communication network 1, for example, handling an XR session, according to embodiments herein will now be described with reference to a flowchart depicted in FIG. 6c. The actions do not have to be taken in the order stated below, but may be taken in any suitable order. Actions performed in some embodiments are marked with dashed boxes.

Action 621. The second radio network node 13 may transmit to the network node 15 or the first radio network node 12, the UE context of one or more UEs, the RRM information and/or the TSCAI describing TSC flow traffic characteristics of the XR application.

Action 622. The second radio network node 13 may receive from the network node 15 or the first radio network node 12, the UE context of one or more UEs, the RRM information and/or the TSCAI describing TSC flow traffic characteristics of the XR application.

Action 623. The second radio network node 13 receives from the first radio network node 12 a message relating to one or more UEs associated with a group of UEs handling or participating in an XR session or application. The message may indicate list of UEs of the group, resource allocation, scheduling design, Dual connectivity setup and/or handover preparation for the given group of UEs.

Action 624. The second radio network node 13 performs a performance action relating to the performance of the XR session or application based on the message, such as handling: resource allocation, scheduling design, Dual connectivity setup and/or handover preparation for the given group of UEs based on the message relating to one or more UEs associated with a group of UEs handling or participating in an XR service, session or application. The performance action may comprise a resource allocation, a scheduling design, a dual connectivity setup and/or a handover preparation for a given group of UEs based on the message. The second radio network node 13 may handle HO of the UE based on the message, and/or handle resources based on the message. The second radio network node 13 may perform the performance action by participating in a group UE handover and/or performing a group UE admission control with a response message including UEs from the group that were successfully accepted for group handover by the second radio network node 13.

Thus;
RAN such as the first and the second radio network node may perform a new function for Group UE handover and group UE admission control over Xn with a Group UE Handover response message including the UEs from the group that were successfully accepted for group handover by the target gNB.
The second radio network node may update the CN of the UE group after each handover for XR UE group awareness. If UEs from the same group end up in different radio network nodes, the signaling in FIG. 7c may take place. Otherwise, the group may be updated and some UEs may be dropped from the group.
New signaling over Xn, and/or F1 may be introduced about group UE information, including ID, related RRM information and XR traffic information supported by RAN.

The method actions performed by the network node 15 for handling communication of the UEs in the communication network, for example, handling an XR session, according to embodiments herein will now be described with reference to a flowchart depicted in FIG. 6d. The actions do not have to be taken in the order stated below, but may be taken in any suitable order. Actions performed in some embodiments are marked with dashed boxes.

Action 631. The network node 15 may obtain group information. The network node 15 may set, receive or retrieve the group information, for example, from a service or application such as an XR application or service.

Action 632. The network node 15 transmits to the first radio network node 12, the indication of group information. The indication may indicate grouping of UEs participating in an XR session or application and/or information relating to the XR session or application such as TSCAI, QoS requirements or similar. The indication may indicate a UE group, for example, a group associated with an XR service or application, in the communication network. Thus, the network node 15 makes the first radio network node 12 aware of the XR UE group.

Action 633. The network node 15 may obtain, such as receive, from the first or the second radio network node, the UE context of one or more UEs, the RRM information and/or the TSCAI describing TSC flow traffic characteristics of the XR application.

Action 634. The network node 15 may provide, such as, transmit to the first or the second radio network node, the UE context of one or more UEs, the RRM information and/or the TSCAI.

Thus:
a CN, i.e., the network node 15 may receive from each UE belonging to a group information on the UE group it belongs (e.g., ID) and its serving NG-RAN's RRM information as well as the TSCAI for the intended XR service.
The network node 15 may send the information or indication to each radio network node hosting a UE belonging to the same UE group of the RRM information of the gNBs serving the UEs in the same group.
A group UE context may be kept at the network node 15 containing the context of each UE belonging to the group and signaling to the NG-RAN(s) serving the UEs of the groups.

FIG. 7a shows a signaling scheme according to some embodiments herein. FIG. 7a shows Grouping UE network registration and resource reservation at the DU where the UE A and the UE B belong to same group served by the same RAN.
The UE A connects to the communication network (action 1).
The UE B connects to the communication network (action 2).
The network node 15 (also referred to as CN), may transmit the indication, such as a multiplayer XR indication for a UE group to the first radio network node 12, such as a central unit of the first radio network node 12 (action 3).
The first radio network node 12 may then trigger or indicate the grouping of the UEs with the group indication, and/or resource allocation, scheduling design, Dual connectivity setup and/or handover preparation for the group (action 4).
The central unit of the first radio network node 12 may provide (transmit) to a distributed unit of the first radio network node 12, an F1 indication indicating resource allocation or reservation and scheduling for the UE grouping (action 5).

FIG. 7b shows a signaling scheme according to some embodiments herein handling HO of group UEs. For example, a group UE handover from the same serving gNB to the same target gNB.
The first radio network node 12, such as a source NG-RAN, may transmit a group UE handover request to the second radio network node 13, such as a target NG-RAN. The HO request may indicate a list of UEs to HO (action 1).
The second radio network node 13 may perform an admission control. For example, the second radio network node 13 may check whether the second radio network node 13 has enough resources for handling the UEs (action 2).
The second radio network node 13 may transmit a response such as a HO response indicating one, a number (one or more), or all of the list of UEs that are accepted (action 3).
The first radio network node 12 may then initiate a HO of indicated UEs (action 4).
The second radio network node 13 may then inform the network node 15 about UEs that have been admitted in for example the group indication (action 5).

FIG. 7c shows a signaling scheme according to some embodiments herein handling communication of group UEs in two different radio network nodes. FIG. 7c shows Inter-node Group UE resource synchronization via CN where UE A and UE B belong to the same group.
The UE A may transmit the indication of group information to the first radio network node 12. The indication may indicate grouping of UEs participating in an XR session or application and/or information relating to the XR session or application, such as TSCAI, quality or service, requirements or similar (action 1).
The UE B may transmit the indication of group information to another first radio network node 12′. The indication may indicate grouping of UEs participating in an XR session or application and/or information relating to the XR session or application such as TSCAI, quality or service, requirements or similar (action 2).
The first radio network node 12 may provide, e.g., upload to the network node 15, UE context of one or more UEs, RRM information and/or TSCAI describing TSC flow traffic characteristics of the XR application (action 3).
The other first radio network node 12′ may provide, e.g., upload to the network node 15, UE context of one or more UEs, RRM information and/or TSCAI describing TSC flow traffic characteristics of the XR application (action 4).
The network node 15 may provide, e.g., download to the first radio network node 12, the UE context of one or more UEs, RRM information and/or TSCAI describing TSC flow traffic characteristics of the XR application, of the other first radio network node 12′ (action 5).
The first radio network node 12 may then perform a resource update based on the received UE context of one or more UEs, RRM information and/or TSCAI describing TSC flow traffic characteristics of the XR application, of the other first radio network node 12′ (action 6).
The network node 15 may provide, e.g., download to the other first radio network node 12′, the UE context of one or more UEs, RRM information and/or TSCAI describing TSC flow traffic characteristics of the XR application, of the first radio network node 12 (action 7).

The other first radio network node 12′ may then perform a resource update based on the received UE context of one or more UEs, RRM information and/or TSCAI describing TSC flow traffic characteristics of the XR application, of the first radio network node 12 (action 8).

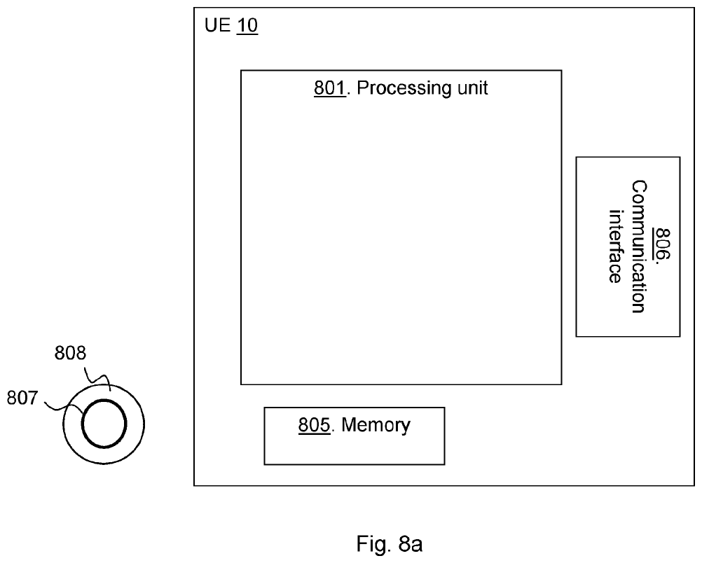

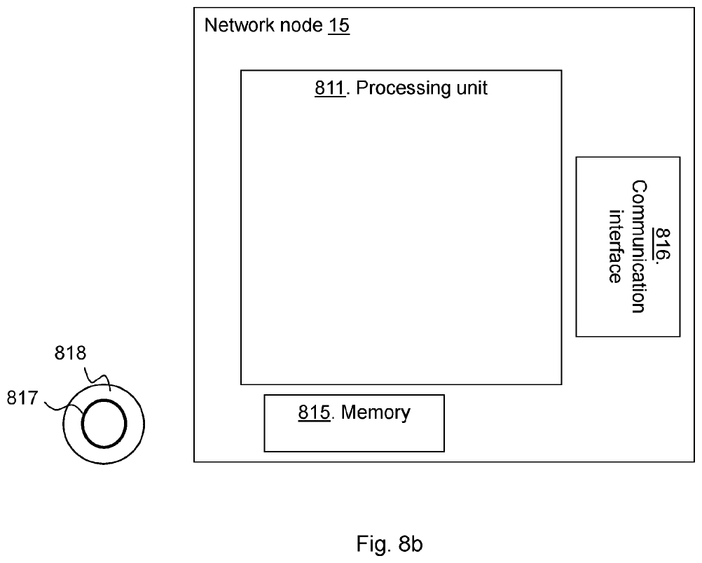

FIG. 8a is a block diagram depicting the UE 10 for handling communication of UEs in the communication network 1 according to embodiments herein.

The UE 10 may comprise processing circuitry 801, e.g., one or more processors, configured to perform the methods herein.

The UE 10 and/or the processing circuitry 801 may be configured to obtain group information of the UEs. The UE 10 and/or the processing circuitry 801 may be configured to set, receive or retrieve the group information, for example, from a service or application such as an XR application or service.

The UE 10 and/or the processing circuitry 801 is configured to transmit to the first radio network node 12, the indication of group information. The indication indicates grouping of UEs participating in the XR session or application and/or information relating to the XR session or application. For example, a group associated with an XR service or application, in the communication network. Thus, the UE 10 and/or the processing circuitry 801 may be configured to make the first radio network node 12 aware of the XR UE group.

The UE 10 and/or the processing circuitry 801 may be configured to obtain, e.g., receive from the first or the second radio network node, UE context of one or more UEs, RRM information and/or TSCAI describing TSC flow traffic characteristics of the XR application.

The UE 10 and/or the processing circuitry 801 may be configured to provide, e.g., transmit, to the first or the second radio network node, UE context of one or more UEs, RRM information and/or TSCAI.

The UE 10 may comprise a memory 805. The memory 805 comprises one or more units to be used to store data on, such as data packets, indications, messages, traffic characteristics, UE context, RRM information, TSCAI, support information, events and applications to perform the methods disclosed herein when being executed, and similar. Furthermore, the UE 10 may comprise a communication interface 806 such as comprising a transmitter, a receiver, a transceiver and/or one or more antennas.

The methods according to the embodiments described herein for the UE 10 are respectively implemented by means of e.g. a computer program product 807 or a computer program, comprising instructions, i.e., software code portions, which, when executed on at least one processor, cause the at least one processor to carry out the actions described herein, as performed by the UE 10. The computer program product 807 may be stored on a computer-readable storage medium 808, e.g., a disc, a universal serial bus (USB) stick or similar. The computer-readable storage medium 808, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose the UE 10 for handling communication of UEs in a communication network, wherein the UE 10 comprises processing circuitry and a memory, said memory comprising instructions executable by said processing circuitry whereby said UE 10 is operative to perform any of the methods herein.

FIG. 8b is a block diagram depicting the network node 15 for handling communication of UEs in the communication network 1 according to embodiments herein.

The network node 15 may comprise processing circuitry 811, e.g., one or more processors, configured to perform the methods herein.

The network node 15 and/or the processing circuitry 811 may be configured to obtain group information. The network node 15 and/or the processing circuitry 811 may be configured to set, receive or retrieve the group information, for example, from a service or application such as an XR application or service.

The network node 15 and/or the processing circuitry 811 is configured to transmit to the first radio network node 12, the indication of group information. The indication indicates grouping of UEs participating in the XR session or application and/or information relating to the XR session or application. For example, a group associated with an XR service or application, in the communication network. Thus, the network node 15 and/or the processing circuitry 811 may be configured to make the first radio network node 12 aware of the XR UE group.

The network node 15 and/or the processing circuitry 811 may be configured to obtain, e.g., receive from the first or the second radio network node, UE context of one or more UEs, RRM information and/or TSCAI describing TSC flow traffic characteristics of the XR application.

The network node 15 and/or the processing circuitry 811 may be configured to provide, e.g., transmit to the first or the second radio network node, UE context of one or more UEs, RRM information and/or TSCAI.

The network node 15 may comprise a memory 815. The memory 815 comprises one or more units to be used to store data on, such as data packets, indications, messages, traffic characteristics, UE context, RRM information, TSCAI, support information, events and applications to perform the methods disclosed herein when being executed, and similar. Furthermore, the network node 15 may comprise a communication interface 816 such as comprising a transmitter, a receiver, a transceiver and/or one or more antennas.

The methods according to the embodiments described herein for the network node 15 are respectively implemented by means of e.g. a computer program product 817 or a computer program, comprising instructions, i.e., software code portions, which, when executed on at least one processor, cause the at least one processor to carry out the actions described herein, as performed by the network node 15. The computer program product 817 may be stored on a computer-readable storage medium 818, e.g., a disc, a universal serial bus (USB) stick or similar. The computer-readable storage medium 818, having stored thereon the computer program product, may comprise the instructions which, when executed on at least one processor, cause the at least one processor to carry out the actions described herein, as performed by the network node 15. In some embodiments, the computer-readable storage medium may be a transitory or a non-transitory computer-readable storage medium. Thus, embodiments herein may disclose the network node 15 for handling communication of UEs in a communication network, wherein the network node 15 comprises processing circuitry and a memory, said memory comprising instructions executable by said processing circuitry whereby said network node 15 is operative to perform any of the methods herein.

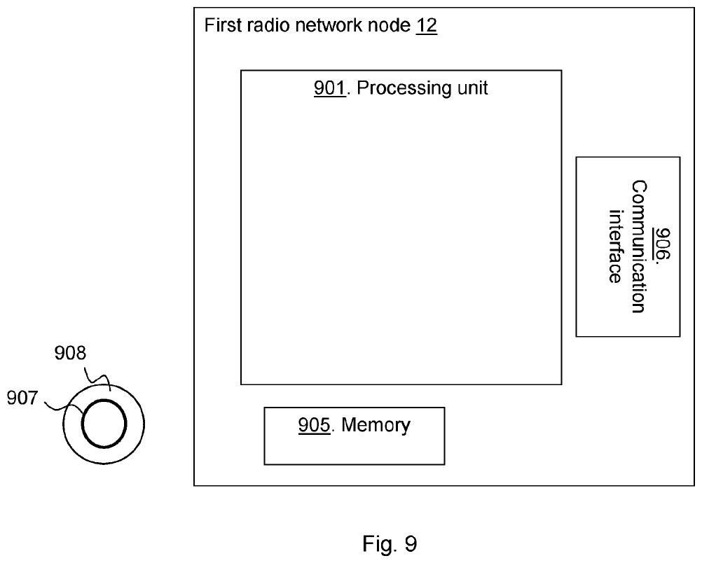

FIG. 9 is a block diagram depicting the first radio network node 12 for handling communication of the UEs in the communication network 1 according to embodiments herein.

The first radio network node 12 may comprise processing circuitry 901, e.g. one or more processors, configured to perform the methods herein.

The first radio network node 12 and/or the processing circuitry 901 is configured to obtain the indication of group information, e.g., receive, the indication from the UE or the network node 15. The indication indicates grouping of UEs participating in an XR session or application and/or information relating to the XR session or application such as TSCAI, quality or service, requirements or similar.

The first radio network node 12 and/or the processing circuitry 901 may be configured to provide, e.g., transmit to the network node or the second radio network node 13, UE context of one or more UEs, RRM information and/or TSCAI describing TSC flow traffic characteristics of the XR application. The traffic characteristics may include a periodicity and/or a jitter information that should be used by the second radio network node 13 for the purpose of scheduling.

The first radio network node 12 and/or the processing circuitry 901 may be configured to obtain, e.g., receive from the network node 15 or the second radio network node 13, UE context of one or more UEs, RRM information and/or TSCAI describing TSC flow traffic characteristics of the XR application.

The first radio network node 12 and/or the processing circuitry 901 is configured to perform the performance action relating to performance of the XR session or application, such as resource allocation, scheduling design, Dual connectivity setup and handover preparation for the given group of UEs, based on the indication. The first radio network node 12 and/or the processing circuitry 901 may be configured to handle HO of the UE taking the indication into account, and/or handle resources taking the indication into account. The first radio network node may be configured to perform the performance action by performing the resource allocation, the scheduling design, the dual connectivity setup and/or the handover preparation for the given group of UEs based on the indication. The first radio network node 12 and/or the processing circuitry 901 may be configured to transmit to the second radio network node 13 a message relating to one or more UEs associated with a group of UEs handling or participating in an XR session or application. The message may indicate list of UEs of the group, resource allocation, scheduling design, Dual connectivity setup and/or handover preparation for the given group of UEs. The traffic characteristics may include a periodicity and/or a jitter information that should be used by the second radio network node 13 for the purpose of scheduling.

The first radio network node 12 may comprise a memory 905. The memory 905 comprises one or more units to be used to store data on, such as data packets, indications, messages, UE context, RRM information, TSCAI, messages, information, events and applications to perform the methods disclosed herein when being executed, and similar. Furthermore, the first radio network node 12 may comprise a communication interface 906 such as comprising a transmitter, a receiver, a transceiver and/or one or more antennas.

The methods according to the embodiments described herein for the first radio network node 12 are respectively implemented by means of e.g. a computer program product 907 or a computer program, comprising instructions, i.e., software code portions, which, when executed on at least one processor, cause the at least one processor to carry out the actions described herein, as performed by the first radio network node 12. The computer program product 907 may be stored on a computer-readable storage medium 908, e.g., a disc, a universal serial bus (USB) stick or similar. The computer-readable storage medium 908, having stored thereon the computer program product, may comprise the instructions which, when executed on at least one processor, cause the at least one processor to carry out the actions described herein, as performed by the first radio network node 12. In some embodiments, the computer-readable storage medium may be a transitory or a non-transitory computer-readable storage medium. Thus, embodiments herein may disclose the first radio network node 12 for handling communication of UEs in a communication network, wherein the first radio network node 12 comprises processing circuitry and a memory, said memory comprising instructions executable by said processing circuitry whereby said first radio network node 12 is operative to perform any of the methods herein.

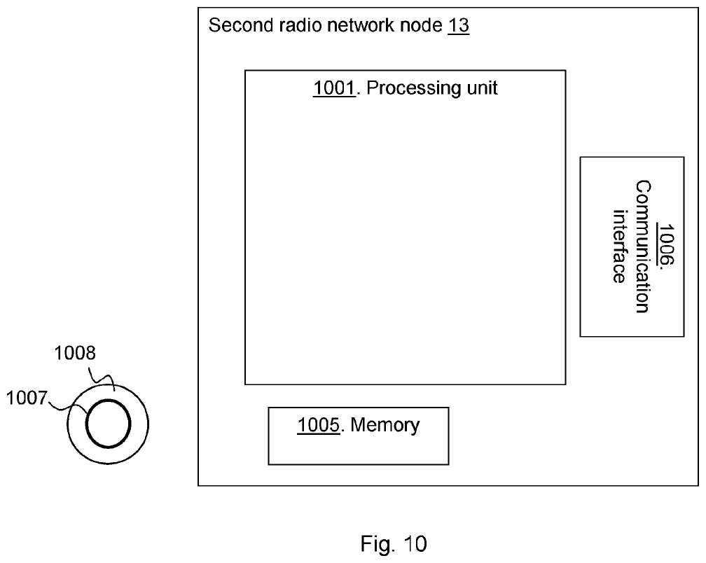

FIG. 10 is a block diagram depicting the second radio network node 13 for handling communication of the UEs in the communication network 1 according to embodiments herein.

The second radio network node 13 may comprise processing circuitry 1001, e.g., one or more processors, configured to perform the methods herein.

The second radio network node 13 and/or the processing circuitry 1001 may be configured to provide, e.g., transmit, to the network node 15 or the first radio network node 12, the UE context of one or more UEs, the RRM information and/or the TSCAI describing TSC flow traffic characteristics of the XR application.

The second radio network node 13 and/or the processing circuitry 1001 may be configured to obtain, e.g., receive, from the network node 15 or the first radio network node 12, the UE context of one or more UEs, the RRM information and/or the TSCAI describing TSC flow traffic characteristics of the XR application.

The second radio network node 13 and/or the processing circuitry 1001 is configured to receive from the first radio network node 12 the message relating to one or more UEs associated with a group of UEs handling or participating in an XR session or application. The message may indicate list of UEs of the group, resource allocation, scheduling design, Dual connectivity setup and/or handover preparation for the given group of UEs.

The second radio network node 13 and/or the processing circuitry 1001 is configured to perform the performance action relating to the performance of the XR session or application based on the message. The second radio network node 13 may, for example, perform resource allocation, scheduling design, Dual connectivity setup and/or handover preparation for the given group of UEs based on the message relating to one or more UEs associated with a group of UEs handling or participating in an XR service, session or application. The second radio network node 13 and/or the processing circuitry 1001 may be configured to handle HO of the UE based on the message, and/or handle resources based on the message. The second radio network node 13 may perform the performance action by participating in a group UE handover and/or performing a group UE admission control with a response message including UEs from the group that were successfully accepted for group handover by the second radio network node 13.

The second radio network node 13 may comprise a memory 1005. The memory 1005 comprises one or more units to be used to store data on, such as data packets, indications, messages, UE context, RRM information, TSCAI, messages, information, events and applications to perform the methods disclosed herein when being executed, and similar. Furthermore, the second radio network node 13 may comprise a communication interface 1006 such as comprising a transmitter, a receiver, a transceiver and/or one or more antennas.

The methods according to the embodiments described herein for the second radio network node 13 are respectively implemented by means of e.g. a computer program product 1007 or a computer program, comprising instructions, i.e., software code portions, which, when executed on at least one processor, cause the at least one processor to carry out the actions described herein, as performed by the second radio network node 13. The computer program product 1007 may be stored on a computer-readable storage medium 1008, e.g., a disc, a universal serial bus (USB) stick or similar. The computer-readable storage medium 1008, having stored thereon the computer program product, may comprise the instructions which, when executed on at least one processor, cause the at least one processor to carry out the actions described herein, as performed by the second radio network node 13. In some embodiments, the computer-readable storage medium may be a transitory or a non-transitory computer-readable storage medium. Thus, embodiments herein may disclose the second radio network node 13 for handling communication of UEs in a communication network, wherein the second radio network node 13 comprises processing circuitry and a memory, said memory comprising instructions executable by said processing circuitry whereby said second radio network node 13 is operative to perform any of the methods herein.

In some embodiments a more general term “network node” or “radio network node” is used and it can correspond to any type of radio-network node or any network node, which communicates with a UE and/or with another network node.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), IoT capable device, machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. NR, Wi-Fi, LTE, LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

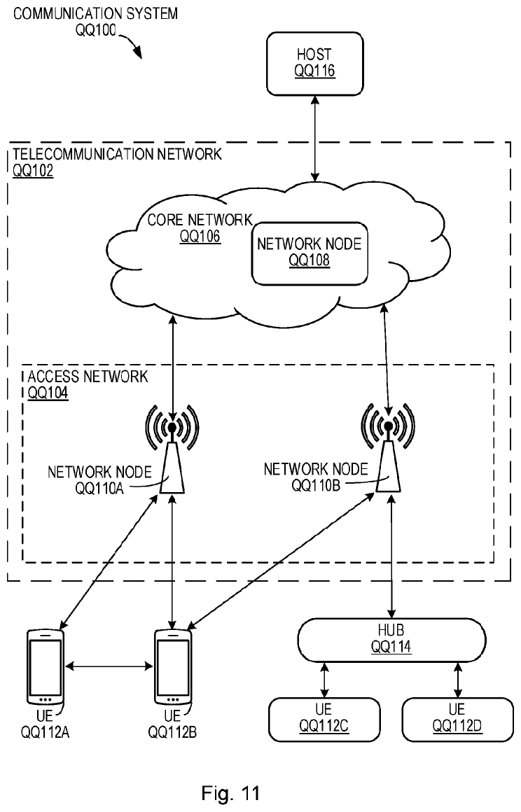

FIG. 11 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110) being examples of the first radio network node 12 and second radio network node 13, or any other similar 3^{rd} Generation Partnership Project (3GPP) access nodes or non-3GPP access points. Moreover, as will be appreciated by those of skill in the art, a network node, being examples of the entities herein, is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of the user equipment (UE) 10, such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) such as network node 15 that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

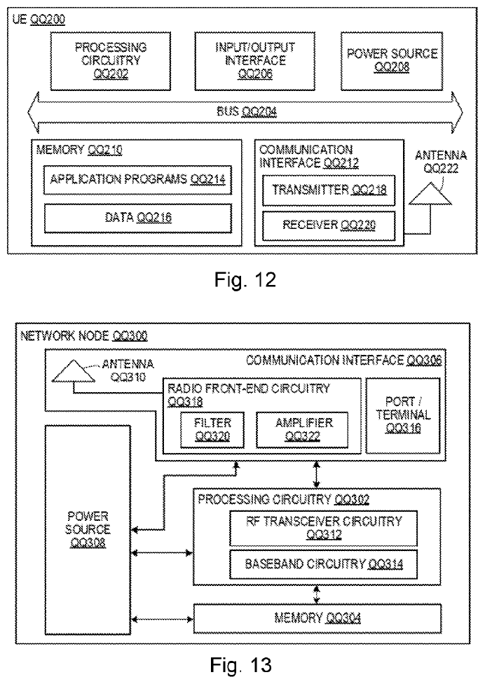

FIG. 12 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 13 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

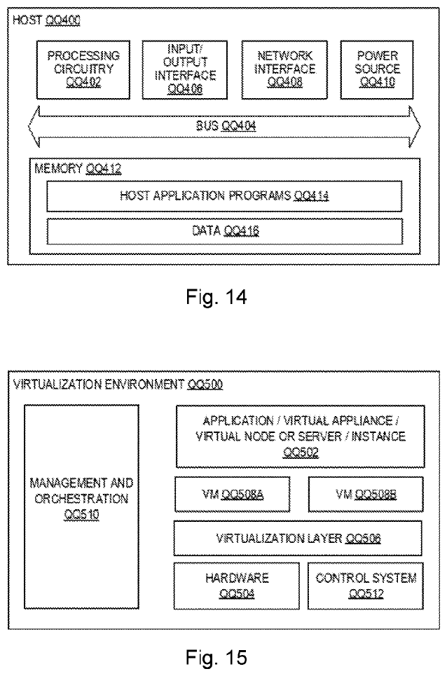

FIG. 14 is a block diagram of a host QQ400, which may be an embodiment of the host QQ116 of FIG. 11, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 12 and 13, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host.

Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

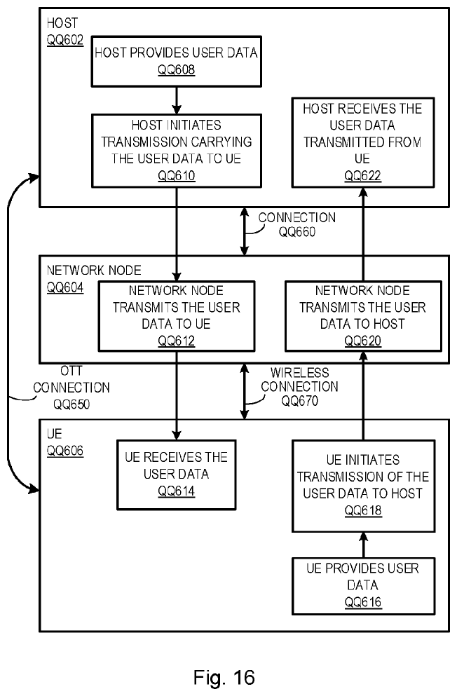

FIG. 16 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 11 and/or UE QQ200 of FIG. 12), network node (such as network node QQ110a of FIG. 11 and/or network node QQ300 of FIG. 13), and host (such as host QQ116 of FIG. 11 and/or host QQ400 of FIG. 14) discussed in the preceding paragraphs will now be described with reference to FIG. 16.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 11) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the operations of UEs and thereby provide benefits such as reduced user waiting time, better responsiveness, better session handling or synchronization of group UEs.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1.-36. (canceled)

37. A method performed by user equipment (UE) operating in a communication network, the method comprising:
transmitting, to a first radio network node of the communication network, an indication of one or more of the following group information:
a group of UEs participating in an extended reality (XR) session or application,
time sensitive communication assistance information (TSCAI) describing time sensitive communication flow traffic characteristics of the XR session or application, and
quality of service (QoS) requirements of the XR session or application.

38. The method according to claim 37, further comprising obtaining the group information from the XR service or application.

39. The method according to claim 37, further comprising sending one or more of the following to the first radio network node or a second radio network node:
UE context for one or more of the group of UEs,
radio resource management (RRM) information, and
the TSCAI.

40. A method performed by a first radio network node of a communication network, the method comprising:
obtaining, from a user equipment (UE) or from a network node of the communication network, an indication of one or more of the following group information:
a group of UEs participating in an extended reality (XR) session or application,
time sensitive communication assistance information (TSCAI) describing time sensitive communication flow traffic characteristics of the XR session or application, and
quality of service (QoS) requirements of the XR session or application; and
based on the indicated group information, performing one or more of the following actions for the group of UEs in relation to the XR session or application: resource allocation, scheduling, dual connectivity setup, and handover preparation.

41. The method according to claim 40, further comprising one of the following:
sending one or more of the following to the network node or a second radio network node:
UE context for one or more of the group of UEs,
radio resource management (RRM) information, and
the TSCAI; or
receiving one or more of the following from the network node or the second radio network node: the UE context, the RRM information, and the TSCAI.

42. The method according to claim 40, wherein the one or more actions also include transmitting to a second radio network node a message that includes or indicates one or more of the following for the group of UEs in relation to the XR session or application: a list of UEs of the group, a resource allocation, scheduling information, a dual connectivity setup, and a handover preparation.

43. A method performed by a second radio network node of a communication network, the method comprising:
receiving from a first radio network node, a message relating to one or more UEs associated with a group of UEs participating in an extended reality (XR) session or application; and
based on the message, performing one or more of the following actions for the group of UEs in relation to the XR session or application: resource allocation, scheduling, dual connectivity setup, and handover preparation.

44. The method according to claim 43, further comprising one of the following:
sending one or more of the following to a network node or the first radio network node:
UE context for the one or more of the group of UEs,
radio resource management (RRM) information, and
time sensitive communication assistance information (TSCAI) describing time sensitive communication flow traffic characteristics of the XR session or application; or
receiving one or more of the following from the network node or the first radio network node: the UE context, the RRM information, and the TSCAI.

45. The method according to claim 43, wherein the one or more actions for the group of UEs also include one or more of the following: group UE handover, group UE admission control, and sending a response message indicating UEs from the group that were accepted for group UE handover by the second radio network node.

46. User equipment (UE) comprising communication interface circuitry and processing circuitry thar are operably coupled and configured to perform the method of claim 37.

47. The UE according to claim 46, wherein the processing circuitry and the communication interface circuitry are further configured to obtain the group information from the XR service or application.

48. The UE according to claim 46, wherein the processing circuitry and the communication interface circuitry are further configured to send one or more of the following to the first radio network node or a second radio network node:
UE context for one or more of the group of UEs,
radio resource management (RRM) information, and
the TSCAI.

49. A first radio network node configured to operate in a communication network, wherein the first radio network node comprises communication interface circuitry and processing circuitry thar are operably coupled and configured to perform the method of claim 40.

50. The first radio network node according to claim 49, wherein the processing circuitry and the communication interface circuitry are further configured to perform one of the following:
send one or more of the following to a network node or the first radio network node:
UE context for the one or more of the group of UEs,
radio resource management (RRM) information, and
time sensitive communication assistance information (TSCAI) describing time sensitive communication flow traffic characteristics of the XR session or application; or
receive one or more of the following from the network node or the first radio network node: the UE context, the RRM information, and the TSCAI.

51. The first radio network node according to claim 49, wherein the one or more actions also include transmit to a second radio network node a message that includes or indicates one or more of the following for the group of UEs in relation to the XR session or application: a list of UEs of the group, a resource allocation, scheduling information, a dual connectivity setup, and a handover preparation.

52. A second radio network node configured to operate in a communication network, wherein the second radio network node comprises communication interface circuitry and processing circuitry thar are operably coupled and configured to perform the method of claim 43.

53. The second radio network node according to claim 52, wherein the processing circuitry and the communication interface circuitry are further configured to perform one of the following:
send one or more of the following to a network node or the first radio network node:
UE context for the one or more of the group of UEs,
radio resource management (RRM) information, and
time sensitive communication assistance information (TSCAI) describing time sensitive communication flow traffic characteristics of the XR session or application; or
receive one or more of the following from the network node or the first radio network node: the UE context, the RRM information, and the TSCAI.

54. The second radio network node according to claim 52, wherein the one or more actions for the group of UEs also include one or more of the following: group UE handover, group UE admission control, and send a response message indicating UEs from the group that were accepted for group UE handover by the second radio network node.

55. A non-transitory, computer-readable medium storing executable instructions that, when executed by processing circuitry of a user equipment (UE), cause the UE to perform the method of claim 37.

56. A non-transitory, computer-readable medium storing executable instructions that, when executed by processing circuitry of a first radio network node of a communication network, cause the first radio network node to perform the method of claim 40.

57. A non-transitory, computer-readable medium storing executable instructions that, when executed by processing circuitry of a second radio network node of a communication network, cause the first radio network node to perform the method of claim 43.
